(19) United States
(12) Patent Application Publication
(10) Pub. No.: US 2005/0096956 A1
(43) Pub. Date: May 5, 2005

(54) Methods and systems of cleaning wares

(76) Inventors: David B. Young, Greensboro, NC (US); Bryan A. Maser, Hugo, MN (US); Lokesh Vij, Eagan, MN (US)

Correspondence Address: IPLM Group, P.A., Post Office Box 18455, Minneapolis, MN, 55418, US

(21) Appl. No.: 10/697,519

(22) Filed: Oct. 30, 2003

(51) Int. Cl. G06F 17/60

(52) U.S. Cl. 705/8

(57) ABSTRACT

System and method of cleaning wares of a plurality of establishments, each of the plurality of establishments having a location and a set of wares. The set of wares are collected from each of the plurality of establishments. The set of wares from all of the plurality of establishments are cleaned following the collecting step. Following the cleaning step, the set of wares are delivered to each respective one of the plurality of establishments.

### TECHNICAL FIELD

This invention relates to methods and systems of cleaning wares and, more particularly, to methods and systems of cleaning wares involving transporting and cleaning wares at a location separate from the location of use of the wares.

### BACKGROUND

Commercial warewashing machines are often employed in industries, such as the restaurant industry, which have a number of wares, such as eating utensils, plates, pots, pans and glassware, utilized in the industry which need to be cleaned, e.g., following usage of the wares. Typically, the wares from a usage at the restaurant are collected and cleaned in a commercial warewashing machine located on the premises of the restaurant, e.g., in or near the kitchen of the restaurant. Such wares are typically cleaned immediately following each use or relatively close to the time of use. When the wares have been cleaned by the commercial warewashing machine, the wares are returned to the restaurant stock for current or future use.

This arrangement requires each establishment, e.g., restaurant, to have and maintain a commercial warewashing machine. Having a commercial warewashing machine is typically a capital expense and, as such, utilizes capital of the establishment which could otherwise be used for a more advantageous purpose. Maintenance and supplies for the commercial dishwashing machine add additional costs for the establishment.

Further, the establishment is at risk if the commercial warewashing machine, on which their business relies, should malfunction or if staff, which is always a problem for establishments like restaurants, fails to show up for duty. If either of these events occurs, the establishment may be out of business or severely handicapped until the machine can be repaired or staff can be obtained. Also, it is usually not practical for such an establishment to maintain their own maintenance staff. This would require the establishment to obtain service from another party often involving a time period before maintenance can occur. During this time the establishment could be out of business or severely handicapped.

### SUMMARY OF THE INVENTION

If cleaning of wares could be outsourced from each of a plurality of such establishments and instead be performed by cleaning such wares at a single location, economy of scale can be achieved. Further, it can be practical for the single location to maintain the warewashing equipment at that location without relying on an outside service provider as would usually have been required by each such establishment. Pickup and delivery vehicles, often the same vehicle both picking up and delivering, can transport the wares of an individual establishment to and from the cleaning establishment.

Outsourcing warewashing in this manner relieves the establishment from the capital cost of the warewashing machine, the necessity of staffing the warewashing machine and eliminates the risk to the establishment of malfunction of the warewashing machine or the inability to properly staff it. Further, the space which the warewashing machine would otherwise occupy and associated loading and unloading space can now be utilized by establishment for more advantageous purposes which could lead to additional income, such as more tables for a restaurant, for example.

In one embodiment, the present invention provides a method of cleaning wares of a plurality of establishments, each of the plurality of establishments having a location and a set of wares. The set of wares are collected from each of the plurality of establishments. The set of wares from all of the plurality of establishments are cleaned following the collecting step. Following the cleaning step, the set of wares are delivered to each respective one of the plurality of establishments.

In a preferred embodiment, the set of wares for each of the plurality of establishments are distinct.

Since it may not be feasible to collect the set of wares from an establishment, clean the wares and deliver the set of wares back to the establishment in time for the establishment to have effective use of the set of wares in the business of the establishment, it may be desirable to stock an additional set of wares, typically beyond what the establishment normally uses in its business. This additional set of wares then allows the collection, e.g., on a vehicle during a route stop, of one set of wares from an establishment and, preferably during the same route stop, deliver the other set of wares, having been cleaned, to the establishment. In this way, the establishment may always have at least one complete set of wares on hand in order to conduct its business while all or part of another set of wares are away from the established in the process of being cleaned, stored, picked up or delivered.

In another embodiment, the present invention provides a method of cleaning wares of a plurality of establishments, each of the plurality of establishments having a distinct location and a distinct set of wares used by the establishment at the distinct location. An inventory of an additional set of the distinct set of wares of each of the plurality of establishments is maintained. At least a portion of the distinct set of wares used by each of the plurality of establishments is collected from each distinct location of the plurality of establishments. The portion of the distinct set of wares collected from the plurality of establishments is cleaned following the collecting step. The wares, having been cleaned, are delivered from the distinct set of wares and from the additional set of distinct wares, to each distinct location for each of the plurality of establishments.

Since it is possible that one complete set of wares may be in use by the establishment and another complete set of wares may be removed from the establishment through a portion of the cleaning process, any failure of the pickup, cleaning or delivery steps of the process could result in the establishment being without all or a portion of a set of wares with which to conduct its business. Therefore, it may be desirable to have an additional set of wares for one or each establishment to have as a safety stock. If any failure should occur in the cleaning process, say a delivery truck should crash, the safety stock set of wares can be used by the establishment without interruption of its business.

In a preferred embodiment, another additional set of distinct wares are maintained for each of the plurality of establishments for use as a safety stock.

An opportunity arises to service an establishment because of the presence of service personnel from the cleaning process in the establishment during the pickup and/or delivery of all or a portion of a set of wares. This cleaning technician has the opportunity to view and, perhaps, talk with personnel of the establishment about cleaning issues of the establishment. Such cleaning issues may have to do with the cleaning of the set of wares or may be related to other cleaning issues of the establishment with which the cleaning service may have or may obtain expertise. The cleaning technician can operate as an effective communicator of such issues to technical consulting personnel. Such communication may not be possible without the presence of such cleaning technician in the establishment.

In another embodiment, the present invention provides a method of providing technical cleaning service to a plurality of establishments, each of the plurality of establishments having a location and a set of wares. The set of wares are collected from each of the plurality of establishments. Following the collecting step, the set of wares from all of the plurality of establishments are cleaned. The set of wares, having been cleaned, are delivered to each respective one of the plurality of establishments. Information relative to cleaning is collected from the plurality of establishments. The information collected is communicated to technical consulting personnel.

In a preferred embodiment, the method further identifies the set of ware as belonging to an individual one of the plurality of establishments.

In a preferred embodiment, the cleaning step is accomplished at a centralized location.

In a preferred embodiment, the collecting step is accomplished regularly.

In a preferred embodiment, the delivering step is accomplished regularly.

In a preferred embodiment, the collecting step and the delivering step occurs along a route, the route having a plurality of stops, and each of the plurality of stops corresponding to each of the plurality of establishments.

In a preferred embodiment, the collecting step and the delivering step are accomplished at each of the plurality of stops along the route.

In a preferred embodiment, the method further charges each of the plurality of establishments an amount based at least partially on an amount of the set of wares cleaned in the cleaning step.

In a preferred embodiment, the communicating step is accomplished at a centralized location.

In another embodiment, the present invention provides a system for cleaning wares of a plurality of establishments, each of a plurality of establishments having a location and a set of wares. A pickup vehicle is adapted to collect the set of wares from each of the plurality of establishments. A cleaning facility is adapted to clean the set of wares from all of the plurality of establishments. A delivery vehicle is adapted to deliver the set of wares, following cleaning, to each respective one of the plurality of establishments.

In a preferred embodiment, the set of wares for each of the plurality of establishments are distinct.

In another embodiment, the present invention provides a system for cleaning wares of a plurality of establishments, each of a plurality of establishments having a distinct location and a distinct set of wares used by the establishment at the distinct location. An inventory of an additional set of the distinct set of wares of each of the plurality of establishments is maintained. A pickup vehicle is adapted to collect at least a portion of the distinct set of wares used by each of the plurality of establishments from each distinct location of the plurality of establishments. A cleaning facility adapted to clean the portion of the distinct set of wares collected from the plurality of establishments. A delivery vehicle is adapted to deliver the set of wares, having been cleaned, from the distinct set of wares and from the additional set of distinct wares, to each distinct location for each of the plurality of establishments.

In a preferred embodiment, another additional set of distinct wares for each of the plurality of establishments is maintained for use as a safety stock.

In a preferred embodiment, each set of wares has identification as belonging to an individual one of the plurality of establishments.

In a preferred embodiment, the identification is used by the delivery vehicle to deliver the set of wares to each respective one of the plurality of establishments.

In another embodiment, the present invention provides a system of providing technical cleaning service to a plurality of establishments, each of the plurality of establishments having a location and a set of wares. A pickup vehicle is adapted to collect the set of wares from each of the plurality of establishments. A cleaning facility is adapted to clean the set of wares from all of the plurality of establishments. A delivery vehicle is adapted to deliver the set of wares, following cleaning, to each respective one of the plurality of establishments. A mechanism is used for collecting information from the plurality of establishments relative to cleaning during at least one of the collecting and the delivering step. A mechanism is used for communicating the information to technical consulting personnel.

In a preferred embodiment, the cleaning facility is centralized.

In a preferred embodiment, the pickup vehicle and the delivery vehicle are the same vehicle.

In a preferred embodiment, the collection and the delivery occurs along a route, the route having a plurality of stops, each of the plurality of stops corresponding to each of the plurality of establishments.

In a preferred embodiment, the collection and the delivery is accomplished at each of the plurality of stops along the route.

In a preferred embodiment, the invention further uses a mechanism for charging each of the plurality of establishments an amount based at least partially on an amount of the set of wares cleaned in the cleaning step.

In a preferred embodiment, the communicating mechanism is centralized.

In a preferred embodiment, cleaning supplies are delivered to at least one of the plurality of establishments.

In a preferred embodiment, the cleaning supplies and the wares are delivered at a single stop at least one of the plurality of establishments.

### BRIEF DESCRIPTION OF THE DRAWING

FIG. 1 is a block diagram of an environment involving a system in accordance with an embodiment of the present invention;

FIG. 2 is a flow chart illustrating an embodiment of a method of the present invention;

FIG. 3 is a flow chart illustrating another embodiment of a method of the present invention utilizing identification of wares;

FIG. 4 is a flow chart illustrating another embodiment of a method of the present invention utilizing a safety stock of wares; and

FIG. 5 is a flow chart illustrating another embodiment of a method of the present invention involving the collection and communicating of cleaning information.

### DETAILED DESCRIPTION

An establishment, such as a restaurant, bar, bistro, cafeteria, cafe, or other establishment involved in the food industry, typically stocks a set of wares for use by the establishment in its business. Such wares may include eating utensils, plates, pots, pans and glassware which are used either by the kitchen in preparing and/or serving the food and/or beverage items or by the customer in consuming the food and/or beverage involved in the establishment's business. If such wares are not disposable, the wares typically must be cleaned prior to being used again in the preparation, serving or consuming of the food and/or beverage items.

Typically, the establishment must dedicate significant resources, e.g., space, capital equipment, utilities and personnel, to clean such wares. This dedication of resources may repeat itself at establishment after establishment existing in roughly the same geographic area. Each establishment typically cleans their own wares and returns the wares to service in their establishment. The result can be a number of establishments, perhaps even similar establishments utilizing similar wares, in a geographic area individually cleaning their own wares.

Instead of dedicating such resources of the establishment, and, in particular, a plurality of establishments, to clean their wares, the wares can be picked up or otherwise collected from the establishments and transported to a warewashing facility where the wares are appropriately cleaned and subsequently returned to each establishment. A cleaning facility, such as a facility dedicated to the cleaning of wares from such establishments, can then clean the wares collected from the plurality of establishments, usually more efficiently than each individual establishment. Following cleaning, the wares can then be returned, or delivered, to each individual establishment. Each establishment would then have the wares available for use.

An establishment has a collection of wares used in the business of the establishment. This collection of wares is sometimes referred to as a set of wares. It is recognized that while an establishment has an entire collection of wares, that not every single ware will necessarily be used in any given time period. In fact, since the establishment probably has enough wares on hand to satisfy a number of potential business possibilities, it is unlikely that an establishment will actually use every single ware in the collection. Wares which are not used likely will not need to be cleaned. It is also likely that more than an individual ware will be used by an establishment during a period of time. These wares, sometimes referred to as a set of wares, will need to be cleaned prior to being used for the next customer or client.

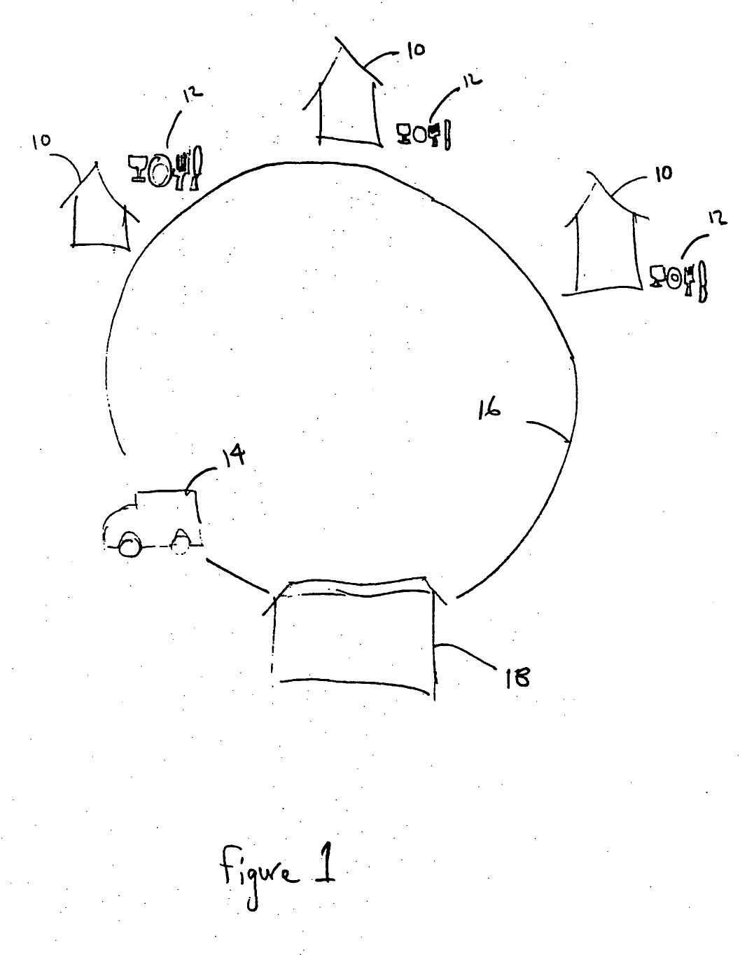

In FIG. 1, a plurality of establishments 10, such as restaurants, each have a set of wares 12 which each establishment 10 uses for its business. A vehicle 14 travels from establishment 10 to establishment 10 picking up and delivering at least a portion of a set of wares 12 from and to each establishment 10 along route 16. Vehicle 14 also stops at cleaning facility 18 where the sets of wares 12 collected from each establishment 10 are cleaned. Following cleaning, vehicle 14, either the same vehicle or another vehicle, delivers the cleaned sets of wares 12 back to establishments 10. Sets of wares 12 are uniquely identified as belonging to an individual establishment, such that each establishment receives back exactly the set of wares 12 which were previously picked up from that establishment. Such unique identification can be done, for example, by applying a label or code to each unit of a set of wares 12 or by applying a label or code to a container or containers in which each set of wares 12 are transported. Such code could be, for example, a bar code which is well known in the art.

Using this system, the cleaning of wares 12 can be outsourced from each of a plurality of such establishments 10 and instead be performed by cleaning such wares 12 at a cleaning facility 18. Pickup and delivery vehicles 14, often the same vehicle both picking up and delivering, can transport the wares 12 of an individual establishment 10 to and from the cleaning facility 18.

Since it may not be feasible to collect the set of wares 12 from an establishment 10, clean the wares at cleaning facility 18 and deliver the set of wares 12 back to the establishment 10 in time for the establishment 10 to have effective use of the set of wares 12 in the business of the establishment, it is desirable to stock an additional set of wares 12, typically beyond what the establishment 10 normally uses in its business. This additional set of wares 12 allows the collection, e.g., on vehicle 14 during a stop along route 16, of one set of wares 12 from an establishment 10 and, preferably during the same stop along route 16, deliver the other set of wares 12, having been cleaned at cleaning facility 18, to the establishment 10. In this way, the establishment 10 may always have at least one complete set of wares 12 on hand in order to conduct its business while all or part of another set of wares 12 are away from the establishment 10 in the process of being cleaned, stored, picked up or delivered.

Further, since it is possible that one complete set of wares 12 may be in use by the establishment 10 and another complete set of wares 12 may be removed from the establishment 10 through a portion of the cleaning process, any failure of the pickup, cleaning or delivery steps of the process could result in the establishment 10 being without all or a portion of a set of wares 12 with which to conduct its business. Therefore, it is desirable to have an additional set of wares 12 for one or each establishment 12 to have as a safety stock. If any failure should occur in the cleaning process, say a vehicle 14 should crash, the safety stock set of wares 12 can be used by the establishment 10 without interruption of its business.

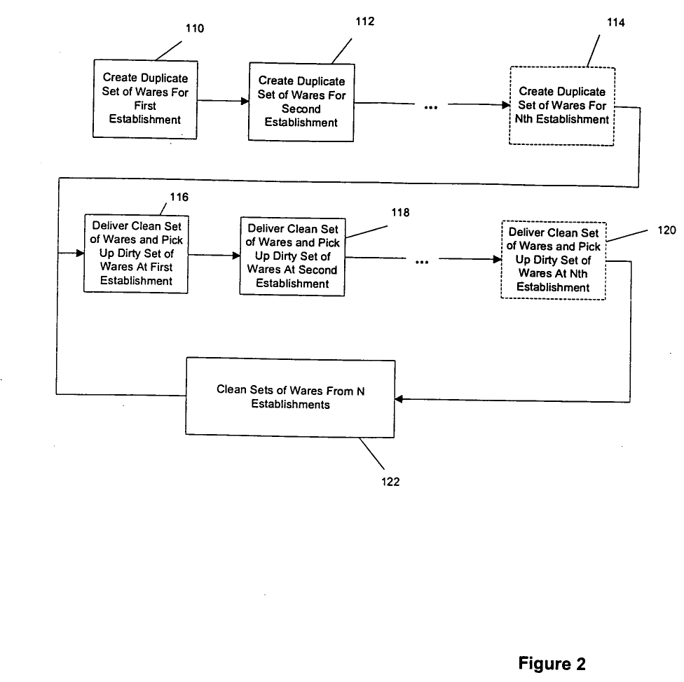

In one embodiment illustrated in FIG. 2, a duplicate set of wares 12 is created [block 110] for a first establishment 10. This process is repeated [blocks 112 and 114] for each additional establishment 10 along route 16. At least a portion of a clean set of wares 12 is delivered [block 116] to the first establishment 10 by vehicle 14 and at least a portion of a dirty set of wares 12 is picked up[also block 116] from the first establishment. In a preferred embodiment, the same vehicle 14 which delivers the clean set of wares 12 also picks up the dirty set of wares 12. This delivery and pickup process is repeated [blocks 118 and 120] for each additional establishment along route 16. Vehicle 14 then transports all of the sets of wares 12 collected from all of establishments 10 to cleaning facility 18 where the sets of wares 12 are cleaned [block 122]. With the clean sets of wares 12 on board, vehicle 14 returns to deliver [block 116] clean wares 12 and pick up [block 116] dirty wares 12 from the first establishment 10 and the delivery and pick up process repeats.

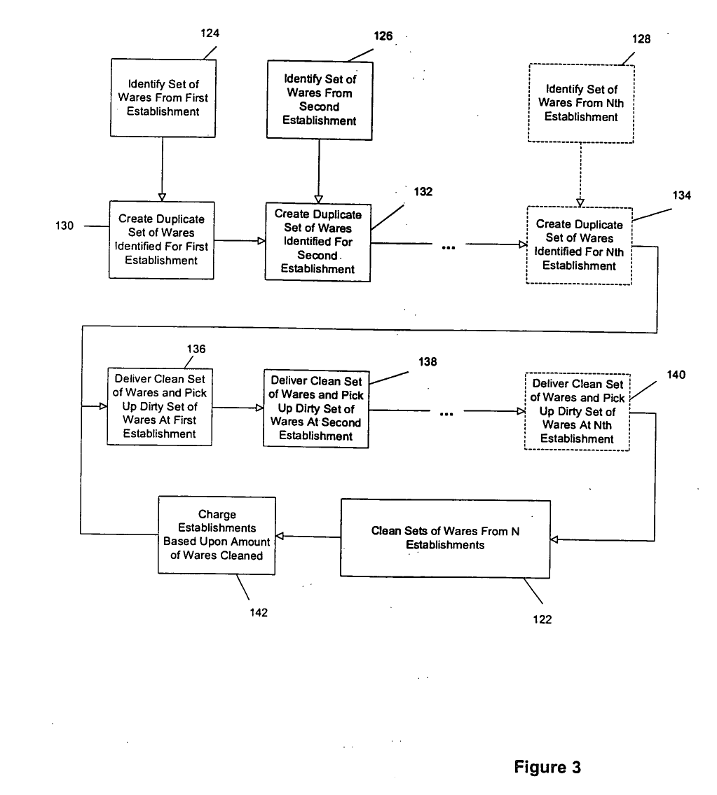

In another embodiment illustrated in FIG. 3, a set of wares 12 is uniquely identified [block 124] as belonging to a first establishment 10. Similarly, another set of wares 12 is uniquely identified [block 126] as belonging to a second establishment 10 and so on until still another set of wares 12 is uniquely identified [block 128] as belonging to an Nth establishment 10. In addition, a duplicate set of wares 12 also uniquely identified is created [block 130] for the first establishment 10. Similarly, another duplicate set of wares 12 also uniquely identified is created [block 132] for the second establishment 10 and so on until still another duplicate set of wares 12 uniquely identified is created [block 134] for the Nth establishment 10.

At least a portion of a clean set of wares 12 is delivered [block 136] to the first establishment 10 by vehicle 14 and at least a portion of a dirty set of wares 12 is picked up[also block 136] from the first establishment. In a preferred embodiment, the same vehicle 14 which delivers the clean set of wares 12 also picks up the dirty set of wares 12. This delivery and pickup process is repeated [blocks 138 and 140] for the second establishment 10 and so one for the Nth establishment 10. Vehicle 14 then transports all of the sets of wares 12 collected from all of establishments 10 to cleaning facility 18 where the sets of wares 12 are cleaned [block 122]. In a preferred embodiment, each establishment 10 is charged [block 142] based at least in part on the amount of wares 12 cleaned from that establishment 10. The tracking and, sometimes subsequent, charging or billing of each establishment 10 can occur at any place along the way of the process. Such charging can occur along the route, e.g., during a visit to an establishment 10 in the process of picking up and/or delivering wares 12, or could occur at another place or places along the process, e.g., from a centralized tracking and billing operation. With the clean sets of wares 12 on board, vehicle 14 returns to deliver [block 136] clean wares 12 and pick up [block 136] dirty wares 12 from the first establishment 10 and the delivery and pick up process repeats.

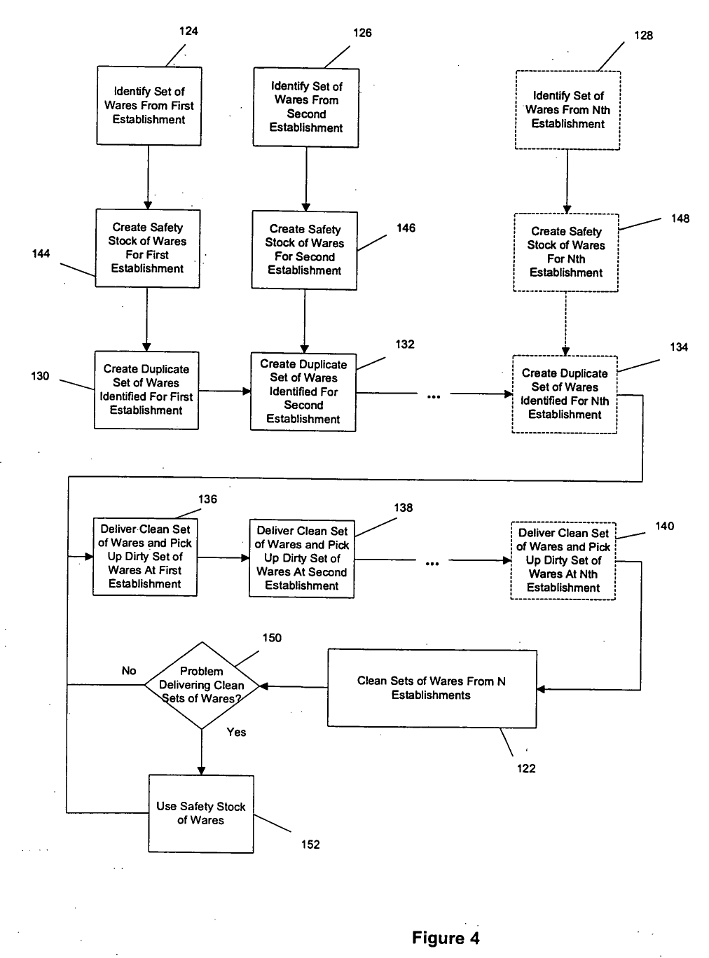

In an alternative embodiment illustrated in FIG. 4, a safety stock of wares 12 is created [block 144], in addition to the identification [block 124] and creation of duplicate set [block 130] performed in FIG. 3. The safety stock of wares 12 is created in order to ensure continued, uninterrupted use of clean wares by a first establishment 10 in the event an event occurs in the process which prevents a clean set of wares being delivered by vehicle 14 to the first establishment. For example, vehicle 14 could break down or, even worse, could be involved in an accident which could ruin at least a portion of a set of wares 12 of first establishment 10, or a catastrophe could occur at cleaning facility 18 which could prevent, at least temporarily, a clean set of wares from being delivered. Alternatively, the event could be as simple as weather or traffic preventing a timely pick-up and/or delivery of wares at first establishment 10. Similarly, a safety stock of wares 12 is created [block 146] for a second establishment 10, in addition to the identification [block 126] and creation of duplicate set [block 132] performed in FIG. 3. This process continues and so on until a safety stock of wares 12 is created [block 148], for an Nth establishment 10, in addition to the identification [block 128] and creation of duplicate set [block 134] performed in FIG. 3.

Deliveries and pick ups are made from the first establishment [block 136], second establishment [block 138] and so on to the Nth establishment [block 140] as in FIG. 3. Similarly, vehicle 14 transports all of the sets of wares 12 collected from all of establishments 10 to cleaning facility 18 where the sets of wares 12 are cleaned [block 122] as in FIG. 3.

If there has not been a problem [block 150] delivering a clean set (or portion thereof) of wares 12 to any of the establishments 10, vehicle 14 with clean sets of wares 12 on board returns to deliver [block 136] clean wares 12 and pick up [block 136] dirty wares 12 from the first establishment 10 and the delivery and pick up process repeats.

However, if there is any problem [block 150] in delivering the previously collected sets of wares, the safety stock of wares (previously created [block 144]) is used [block 152] and delivered [block 136] to the first establishment 10. Similarly, if a problem has developed [block 150] in delivering previously collected wares 12 from the second establishment 10 or the Nth establishment 10, the safety stock of wares 12 associated with that establishment 10 are used and delivered [block 138 and/or block 140] to the second establishment 10 or Nth establishment 10, respectively.

Subsequently, it is preferred that either the set of wares 12 with which there has been a problem [block 150] be recovered for either use as a safety stock or delivered to the establishment and the original safety stock set of wares 12 be recovered.

An opportunity arises to service an establishment 10 because of the presence of service personnel from the cleaning process in the establishment 10 during the pickup and/or delivery[e.g., block 136] of all or a portion of a set of wares. This service personnel, e.g., cleaning technician, has the opportunity to view and, perhaps, talk with personnel of the establishment 10 about cleaning issues of the establishment 10. Such cleaning issues may have to do with the cleaning of the set of wares 12 or may be related to other cleaning issues of the establishment 10 with which the cleaning service may have or may obtain expertise. The cleaning technician can operate as an effective communicator of such issues to technical consulting personnel. Such communication may not be possible without the presence of such cleaning technician in the establishment 10.

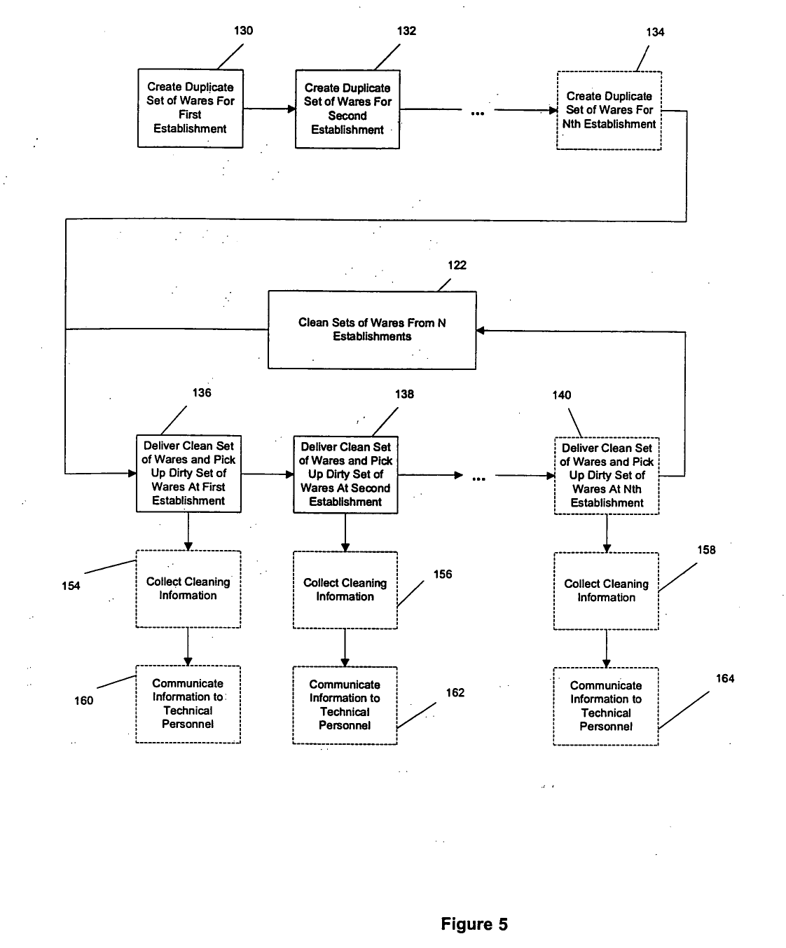

In an alternative embodiment illustrated in FIG. 5, duplicate sets of wares 12 are created [blocks 130, 132 and 134] as previously described. Similarly, deliveries and pick ups are made from the first establishment [block 136], second establishment [block 138] and so on to the Nth establishment [block 140] as in FIG. 3. Again, vehicle 14 transports all of the sets of wares 12 collected from all of establishments 10 to cleaning facility 18 where the sets of wares 12 are cleaned [block 122] as in FIG. 3.

At a particular stop at an establishment 10 along route 16, cleaning related information can be collected [blocks 154, 156 and/or 158] from an establishment 10 by a variety of means such as directly talking with personnel of the establishment 10 or making observations. Observations could include the condition of establishment 10, apparent or not so apparent cleaning needs of establishment 10, helpful information which could be delivered to the establishment 10 and potential sales opportunities. The cleaning technician may act on this information directly or, in a preferred embodiment, this information can be communicated [blocks 160, 162 and/or 164] to appropriate personnel, such as technical personnel, where it can be followed up on and subsequently acted upon.

Optionally and in a preferred embodiment, cleaning supplies, such as detergents, rinse aids, disinfectants, cleaners and the like, can be delivered to at least one of each respective establishment 10 during delivery steps 136, 138 and 140. Preferably, the cleaning supplies delivered will be based, at least in part, on the information gained from each establishment 10 in blocks 154, 156 and 158.

Various modifications and alterations of this invention will be apparent to those skilled in the art without departing from the scope and spirit of this invention. It should be understood that this invention is not limited to the illustrative embodiments set forth above.

1. A method of cleaning wares of a plurality of establishments, each of said plurality of establishments having a location and a set of wares, comprising the steps of:
collecting said set of wares from each of said plurality of establishments;
cleaning said set of wares from all of said plurality of establishments following said collecting step; and
delivering said set of wares, following said cleaning step, to each respective one of said plurality of establishments.

2. A method as in claim 1 wherein said set of wares for each of said plurality of establishments are distinct.

3. A method as in claim 1 further comprising the step of identifying said set of wares as belonging to an individual one of said plurality of establishments.

4. A method as in claim 1 wherein said cleaning step is accomplished at a centralized location.

5. A method as in claim 1 wherein said collecting step is accomplished regularly.

6. A method as in claim 5 wherein said delivering step is accomplished regularly.

7. A method as in claim 6 wherein said collecting step and said delivering step occurs along a route, said route having a plurality of stops, each of said plurality of stops corresponding to each of said plurality of establishments.

8. A method as in claim 7 wherein said collecting step and said delivering step is accomplished at each of said plurality of stops along said route.

9. A method as in claim 1 further comprising the step of charging each of said plurality of establishments an amount based at least partially on an amount of said set of wares cleaned in said cleaning step.

10. A method as in claim 1 further comprising the step of delivering cleaning supplies to at least one of said plurality establishments.

11. A method as in claim 10 wherein said step of delivering cleaning supplies and said step of delivering said set of wares occurs during a single stop at least one of said plurality of establishments.

12. A method of cleaning wares of a plurality of establishments, each of said plurality of establishments having a distinct location and a distinct set of wares used by said establishment at said distinct location, comprising the steps of:
maintaining an inventory of an additional set of said distinct set of wares of each of said plurality of establishments;
collecting at least a portion of said distinct set of wares used by each of said plurality of establishments from each distinct location of said plurality of establishments;
cleaning said portion of said distinct set of wares collected from said plurality of establishments following said collecting step; and
delivering wares, having been cleaned, from said distinct set of wares and from said additional set of distinct wares, to each distinct location for each of said plurality of establishments.

13. A method as in claim 12 further comprising the step of maintaining another additional set of distinct wares for each of said plurality of establishments for use as a safety stock.

14. A method as in claim 12 further comprising the step of identifying said set of wares as belonging to an individual one of said plurality of establishments prior to said collecting step.

15. A method as in claim 12 wherein said cleaning step is accomplished at a centralized location.

16. A method as in claim 12 wherein said collecting step is accomplished regularly.

17. A method as in claim 16 wherein said delivering step is accomplished regularly.

18. A method as in claim 17 wherein said collecting step and said delivering step occurs along a route, said route having a plurality of stops, each of said plurality of stops corresponding to each of said plurality of establishments.

19. A method as in claim 18 wherein said collecting step and said delivering step is accomplished at each of said plurality of stops along said route.

20. A method as in claim 12 further comprising the step of charging each of said plurality of establishments an amount based at least partially on an amount of said set of wares cleaned in said cleaning step.

21. A method as in claim 12 further comprising the step of delivering cleaning supplies to at least one of said plurality establishments.

22. A method as in claim 21 wherein said step of delivering cleaning supplies and said step of delivering wares occurs during a single stop at least one of said plurality of establishments.

23. A method of providing technical cleaning service to a plurality of establishments, each of said plurality of establishments having a location and a set of wares, comprising the steps of:
collecting said set of wares from each of said plurality of establishments;
cleaning said set of wares from all of said plurality of establishments following said collecting step;
delivering said set of wares, following said cleaning step, to each respective one of said plurality of establishments;
collecting information from said plurality of establishments relative to cleaning during at least one of said collecting and said delivering step; and
communicating said information to technical consulting personnel.

24. A method as in claim 23 wherein said set of wares for each of said plurality of establishments are distinct.

25. A method as in claim 23 further comprising the step of identifying said set of wares as belonging to an individual one of said plurality of establishments prior to said collecting step.

26. A method as in claim 23 wherein said cleaning step is accomplished at a centralized location.

27. A method as in claim 23 wherein said collecting step is accomplished regularly.

28. A method as in claim 27 wherein said delivering step is accomplished regularly.

29. A method as in claim 28 wherein said collecting step and said delivering step occurs along a route, said route having a plurality of stops, each of said plurality of stops corresponding to each of said plurality of establishments.

30. A method as in claim 29 wherein said collecting step and said delivering step is accomplished at each of said plurality of stops along said route.

31. A method as in claim 23 further comprising the step of charging each of said plurality of establishments an amount based at least partially on an amount of said set of wares cleaned in said cleaning step.

32. A method as in claim 23 wherein said communicating step is accomplished to a centralized location.

33. A method as in claim 23 further comprising the step of delivering cleaning supplies to at least one of said plurality establishments.

34. A method as in claim 33 wherein said step of delivering cleaning supplies and said step of delivering said set of wares occurs during a single stop at least one of said plurality of establishments.

35. A system for cleaning wares of a plurality of establishments, each of a plurality of establishments having a location and a set of wares, comprising:
a pickup vehicle adapted to collect said set of wares from each of said plurality of establishments;
a cleaning facility adapted to clean said set of wares from all of said plurality of establishments; and
a delivery vehicle adapted to deliver said set of wares, following cleaning, to each respective one of said plurality of establishments.

36. A system as in claim 35 wherein said set of wares for each of said plurality of establishments are distinct.

37. A system as in claim 35 wherein said set of wares have an identification as belonging to an individual one of said plurality of establishments prior to collection.

38. A system as in claim 37 wherein said identification is used by said delivery vehicle to deliver said set of wares to each respective one of said plurality of establishments.

39. A system as in claim 35 wherein said cleaning facility is centralized.

40. A system as in claim 35 wherein said pickup vehicle and said delivery vehicle are the same vehicle.

41. A system as in claim 40 wherein said vehicle accomplishes said collection and said delivery along a route, said route having a plurality of stops, each of said plurality of stops corresponding to each of said plurality of establishments.

42. A system as in claim 41 wherein said collection and said delivery is accomplished at each of said plurality of stops along said route.

43. A system as in claim 35 further comprising means for charging each of said plurality of establishments an amount based at least partially on an amount of said set of wares cleaned in said cleaning step.

44. A system as in claim 35 wherein said delivery vehicle is adapted to deliver cleaning supplies to at least one of said plurality establishments.

45. A system as in claim 44 wherein said cleaning supplies and said set of wares are delivered during a single stop at least one of said plurality of establishments.

46. A system for cleaning wares of a plurality of establishments, each of a plurality of establishments having a distinct location and a distinct set of wares used by said establishment at said distinct location, comprising:
an inventory of an additional set of said distinct set of wares of each of said plurality of establishments;
a pickup vehicle adapted to collect at least a portion of said distinct set of wares used by each of said plurality of establishments from each distinct location of said plurality of establishments;
a cleaning facility adapted to clean said portion of said distinct set of wares collected from said plurality of establishments; and
a delivery vehicle adapted to deliver said set of wares, having been cleaned, from said distinct set of wares and from said additional set of distinct wares, to each distinct location for each of said plurality of establishments.

47. A system as in claim 46 further comprising another additional set of distinct wares for each of said plurality of establishments for use as a safety stock.

48. A system as in claim 46 wherein said set of wares have an identification as belonging to an individual one of said plurality of establishments.

49. A system as in claim 46 wherein said cleaning facility is centralized.

50. A system as in claim 46 wherein said pickup vehicle and said delivery vehicle are the same vehicle.

51. A system as in claim 50 wherein said vehicle accomplishes said collection and said delivery along a route, said route having a plurality of stops, each of said plurality of stops corresponding to each of said plurality of establishments.

52. A system as in claim 51 wherein said collection and said delivery is accomplished at each of said plurality of stops along said route.

53. A system as in claim 46 further comprising means for charging each of said plurality of establishments an amount based at least partially on an amount of said set of wares cleaned in said cleaning step.

54. A system as in claim 46 wherein said delivery vehicle is adapted to deliver cleaning supplies to at least one of said plurality establishments.

55. A system as in claim 54 wherein said cleaning supplies and said set of wares are delivered during a single stop at least one of said plurality of establishments.

56. A system of providing technical cleaning service to a plurality of establishments, each of said plurality of establishments having a location and a set of wares, comprising:
a pickup vehicle adapted to collect said set of wares from each of said plurality of establishments;
a cleaning facility adapted to clean said set of wares from all of said plurality of establishments;
a delivery vehicle adapted to deliver said set of wares, following cleaning, to each respective one of said plurality of establishments;
means for collecting information from said plurality of establishments relative to cleaning during at least one of said collecting and said delivering step; and
means for communicating said information to technical consulting personnel.

57. A system as in claim 56 wherein said set of wares for each of said plurality of establishments are distinct.

58. A system as in claim 57 wherein said set of wares have an identification as belonging to an individual one of said plurality of establishments prior to collection.

59. A system as in claim 56 wherein said cleaning facility is centralized.

60. A system as in claim 56 said pickup vehicle and said delivery vehicle is the same vehicle.

61. A system as in claim 60 wherein said collection and said delivery occurs along a route, said route having a plurality of stops, each of said plurality of stops corresponding to each of said plurality of establishments.

62. A system as in claim 61 wherein said collection and said delivery is accomplished at each of said plurality of stops along said route.

63. A system as in claim 56 further comprising means for charging each of said plurality of establishments an amount based at least partially on an amount of said set of wares cleaned in said cleaning step.

64. A system as in claim 56 wherein said means for communicating is centralized.

65. A system as in claim 56 wherein said delivery vehicle is adapted to deliver cleaning supplies to at least one of said plurality establishments.

66. A system as in claim 65 wherein said cleaning supplies and said set of wares are delivered during a single stop at least one of said plurality of establishments.
